(19) United States
(12) Patent Application Publication
(10) Pub. No.: US 2014/0165187 A1
(43) Pub. Date: Jun. 12, 2014

(54) Method, Apparatus, and Computer-Readable Recording Medium for Authenticating a User

(71) Applicants: Kim Daesung, Guri-si (KR); Jihee Cheon, Seoul (KR)

(72) Inventors: Kim Daesung, Guri-si (KR); Jihee Cheon, Seoul (KR)

(21) Appl. No.: 13/976,558

(22) PCT Filed: Dec. 28, 2012
(86) PCT No.: PCT/KR2012/011734

§ 371 Date: Jan. 14, 2014

(30) Foreign Application Priority Data
Dec. 29, 2011 (KR) 1020110146347

(51) Int. Cl. G06F 21/32

(52) U.S. Cl. CPC G06F 21/32
USPC 726/19

(57) ABSTRACT

Provided are a method, apparatus, and computer-readable recording medium for authenticating a user. The user authentication method includes obtaining an image including a face and a face movement by driving a camera to extract feature information on a facial image and a movement pattern from the obtained image, and comparing the extracted feature information on the facial image with feature information on a facial image registered in a storage and, when the extracted feature information matches the registered feature information, comparing the extracted movement pattern with a movement pattern registered in the storage and, when the extracted movement pattern matches the registered movement pattern, unlocking a device.

### TECHNICAL FIELD

The present disclosure relates to a method, apparatus, and computer-readable recording medium for authenticating a user. In the present disclosure, since a device is unlocked by recognizing a movement of a face (for example, the number of blinks, a rotation direction of a head, etc.), the device can be prevented from being unlocked by a facial image obtained from a still image such as a photograph, instead of an actual face.

### BACKGROUND ART

Biometric recognition is a technology for recognizing different body features of persons such as fingerprints, facial patterns, irises of eyes, etc., which may be used to authorize certain access, for example, to a device. Unlike keys or passwords, body features cannot be stolen or duplicated and do not have a risk of being changed or lost. Therefore, body features may be utilized in the security field.

In the biometric recognition field, face recognition technology includes a technology that detects a face region from a video or photograph image and identifies a face included in the detected face region. Thus, in a smart phone or tablet Personal Computer (PC) space, face recognition may be applied to various applications, including security purposes.

For face recognition technology generally applied to devices such as smart phones or tablet PCs, a facial region may be detected from a video or photograph image and the detected facial image may be compared with a facial image previously registered and stored, to authenticate a user and thereby unlock the respective device.

However, in this technology, a facial image may be obtained from an actual face as well as from a photograph, and compared with a facial image previously stored in a storage part to authenticate a user and thereby unlock the device.

Therefore, another user, who is not a real user, may obtain a facial image of the real user from his/her photograph and get authentication, and thus it is vulnerable to security risks.

Moreover, a scanned facial image may vary according to an ambient environment such as illumination, and thus, when comparing the scanned facial image with a registered facial image for recognizing a face, the success rate of such face recognition could be considerably reduced. Also, a face of the same user may vary as time passed or due to artificial makeup or cosmetic procedures. Thus, even though a facial image of a registered user (e.g., having a registered image in a storage) is scanned, it is possible the authentication for the same registered user may fail.

### DISCLOSURE

### Technical Problem

The present disclosure provides various embodiments of a method, apparatus, and computer-readable recording medium for overcoming all of the above-described limitations occurring in the prior art.

### Technical Solution

Various configurations of the present disclosure for achieving the objects of the present disclosure and realizing the characteristic effects of the present disclosure are as follows.

The present disclosure provides some embodiments of a method, apparatus, and computer-readable recording medium for authenticating a user, in which a device is unlocked by recognizing a movement of a face (for example, the number of blinks, a rotation direction of a head, etc.), and thus the device can be prevented from being unlocked by a facial image obtained from a still image such as a photograph, instead of an actual face.

The present disclosure provides some embodiments of a method, apparatus, and computer-readable recording medium for authenticating a user, in which a storage stores registered passwords/patterns, face information and movement patterns for each user, and when a user inputs his/her face and face movement to request to access a device but a scanned facial image and movement pattern of the user do not match the registered facial image and movement pattern, the inputted password/pattern may be compared with the registered password/pattern so that the scanned facial image and movement pattern are added to effect an update of the registered facial image and movement pattern when the inputted password/pattern matches the registered password or pattern.

According to an aspect of the present disclosure, a user authentication method comprises: (a) obtaining an image including a face and a face movement by driving a camera to extract a facial image and a movement pattern from the obtained image; and (b) comparing the extracted facial image with a facial image registered in a storage and, when the extracted facial image matches the registered facial image, comparing the extracted movement pattern with a movement pattern registered in the storage and, when the extracted movement pattern matches the registered movement pattern, unlocking a device.

Moreover, the method may further include: (c) comparing the extracted facial image and movement pattern with the facial image and movement pattern registered in the storage, when there is a mismatch therebetween, requesting a password or a pattern; and (d) when the password or pattern matches the registered password or pattern, unlocking the device, and adding the extracted the facial image and the extracted movement pattern to the storage to effect an update.

According to another aspect of the present disclosure, an apparatus for authenticating a user which comprises: a storage for storing a registered facial image and a registered movement pattern; a camera for scanning a face; a display unit for displaying a face authentication window; and a control unit for providing the face authentication window to the display unit, obtaining an image including a face and a face movement by driving the camera for authenticating the face to extract a facial image and a movement pattern from the obtained image, comparing the extracted facial image with the facial image registered in the storage and, when the extracted facial image matches the registered facial image, comparing the extracted movement pattern with the movement pattern registered in the storage and, when the extracted movement pattern matches the registered movement pattern, unlocking a device.

Moreover, the storage may store a registered password or pattern. In this case, the control unit may compare the password or pattern with the registered password or pattern, and when the password or pattern matches the registered password or pattern, the control unit may unlock the device and add the extracted facial image and movement pattern to the storage to effect an update.

### Advantageous Effects

According to the present disclosure, since a device is unlocked by recognizing the movement of a face, the device can be prevented from being unlocked by a facial image obtained from a still image such as a photograph, instead of an actual face. Therefore, security vulnerability could be overcome.

According to the present disclosure, a storage may store registered passwords/patterns, facial images and movement patterns for a user. If a user inputs his/her face and face movement to request an access to a device but the user's scanned facial image and movement pattern is not matched with the registered facial image and movement pattern, a password or pattern may be inputted and compared with the registered password or pattern. Then, if the inputted password or pattern is matched with the registered password or pattern, the registered facial image and movement pattern are updated with the scanned facial image and movement pattern, and thus the device is unlocked. Accordingly, in authenticating a user at a later time, a recent face and face movement of the user may be used for face authentication, thereby enhancing the authentication success rate.

### DESCRIPTION OF DRAWINGS

FIG. 1 is a block diagram illustrating a configuration of a user authentication apparatus according to an embodiment of the present disclosure.

FIG. 2 is a flowchart for describing a user authentication method according to an embodiment of the present disclosure.

FIG. 3 is a flowchart for describing a user authentication method according to another embodiment of the present disclosure.

FIG. 4 is a flowchart for describing a face registration operation according to an embodiment of the present disclosure.

FIG. 5 is a flowchart for describing an operation of registering a password or a pattern according to an embodiment of the present disclosure.

FIG. 6 is a flowchart illustrating an operation that extracts a facial image and a movement pattern from an obtained face and face movement and compares the extracted facial image and movement pattern with a registered facial image and movement pattern, according to an embodiment of the present disclosure.

FIG. 7 is a flowchart illustrating an operation that extracts a facial image and a movement pattern from a captured face and face movement and compares the extracted facial image and movement pattern with a registered facial image and movement pattern, according to another embodiment of the present disclosure.

### MODE FOR INVENTION

The present disclosure is described in detail with reference to the accompanying drawings in connection with specific embodiments in which the present disclosure can be implemented. The embodiments are described in detail in order for those having ordinary skill in the art to practice the present disclosure. It is to be understood that the various embodiments of the present disclosure differ from each other, but need not to be mutually exclusive. For example, a specific shape, structure, and characteristic described herein in relation to an embodiment can be implemented in another embodiment without departing from the spirit and scope of the present disclosure. It should be noted that the position or arrangement of each element within each disclosed embodiment can be modified without departing from the spirit and scope of the present disclosure. Accordingly, the following detailed description should not be construed as limiting the present disclosure. The scope of the present disclosure is limited by only the appended claims and equivalent thereof. The same reference numbers are used throughout the drawings to refer to the same parts.

Hereinafter, various embodiments of the present disclosure are described with reference to the accompanying drawings in order for those skilled in the art to be able to readily practice them.

As background, Korean Patent Publication No. 10-2004-67122 discloses a method for authenticating a user on the basis of a password and face recognition information, which allows an input result of a password to effectuate the performance of face recognition or allows for a feedback mechanism that involves a face recognition and a subsequent recognition operation so that the probability of a failed authentication of a registered user or erroneously granting access to an unregistered user is reduced. However, in this method, since authentication can be performed using a user's photograph, it is vulnerable to security breaches.

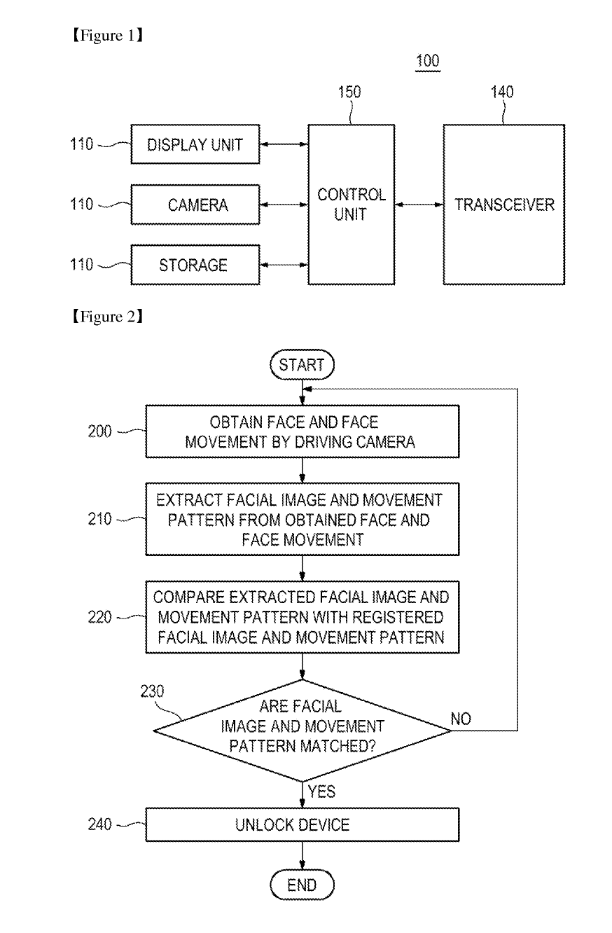

FIG. 1 is a block diagram illustrating a configuration of a user authentication apparatus 100 according to an embodiment of the present disclosure. Referring to FIG. 1, the user authentication apparatus 100 includes a display unit 110, a camera 120, a storage device 130, a transceiver 140, and a control unit 150.

The following description is made on respective functions of elements illustrated in FIG. 1.

A touch sensor may be attached to the display unit 110 and thus a user may touch a screen to input data. When a user authentication application displayed on the screen is touched, a user authentication setting window may be displayed on the display unit 110. When a password/pattern registration function is selected in the user authentication setting window, a password/pattern input window may be displayed. At this point, if a face and face movement registration function is selected, a camera capture function on a screen may be touched to capture a face and face movement of the user. Moreover, after the user authentication setting is completed, a user authentication window including a face and face movement authentication window and/or a password/pattern authentication window for user authentication may be displayed. For example, the password authentication window denotes a window for inputting numbers or letters or inputting numbers and letters, and the pattern authentication window denotes a window for inputting a pattern that is generated from connecting a plurality of nodes (having a certain arrangement) displayed on the display unit 110. For example, products (iPhone and iPad) manufactured by Apple Inc. display a password window for authenticating a user, and products (Galaxy S and Galaxy Tap) manufactured by Samsung Electronics display a pattern authentication window for authenticating a user.

The camera 120 may capture the user's face when the camera capture function of the display unit 110 is selected.

The storage 130 may store the user authentication application and may store a registered password/pattern, and a registered facial image and face movement pattern.

If the user authentication application is not stored in the storage 130, the transceiver 140 may access an application providing server (not shown) and receive the user authentication application over a communication network (not shown).

When the user authentication application displayed on the display unit 110 is selected by the user, the control unit 150 may execute the user authentication application stored in the storage 130 to display the user authentication setting window on the display unit 110. When a password/pattern setting function is selected by the user, the control unit 150 may provide the password/pattern input window on the display unit 110. For example, when the same password/pattern is inputted two times, the inputted password/pattern may be registered, and when the same facial image is inputted two times, the inputted facial image and face movement pattern may be registered. Here, the number of times may vary less or greatly.

The user authentication apparatus 100 of FIG. 1 may be a terminal such as a smart phone or a tablet PC which may previously store the user authentication application or alternatively may access the application providing server to receive the user authentication application. In addition, the password/pattern registration function may be provided by the smart phone or the tablet PC and the face registration function may be performed by executing the user authentication application. In this case, the smart phone or the tablet PC may access the application providing server to receive the user authentication application and register a facial image and a face movement pattern.

FIG. 2 is a flowchart for describing a user authentication method according to an embodiment of the present disclosure. A password/pattern and/or a facial image and a movement pattern are pre-registered in the user authentication apparatus 100 and stored in the storage 130 through the above described procedure. In this case, an operation in which a user authentication window is displayed is described with respect to FIG. 2.

At 200, when a user attempts to authenticate for using the user authentication apparatus 100, the camera 120 is driven and the face authentication window is displayed on the display unit 110, and a face and a face movement are captured.

At 210, a facial image and a face movement pattern are extracted from the captured face and face movement. Here, the extracted facial image may include feature information on the facial image, and the face movement pattern may include at least one of the number of expressions such as the number of blinks of eyes, a rotation direction of a head, and a movement direction. For example, if the obtained image includes another image as well as the facial image, the facial image may be extracted by a knowledge-based method, a feature-based method, or a template-matching method.

At 220, the user authentication apparatus 100 compares the extracted facial image and face movement pattern with a facial image and face movement pattern registered in the storage 130. The facial image registered in the storage 130 may include feature information on the facial image, and the face movement pattern may include at least one of the number of expressions such as the number of blinks of eyes and a rotation direction of a head. At 220, the feature information on the extracted facial image may be compared with feature information on the registered facial image, and the extracted facial image and face movement pattern may be compared with the registered facial image and face movement pattern.

At 230, the user authentication apparatus 100 determines whether the extracted facial image and face movement pattern match the registered facial image and face movement pattern. Here, the user authentication apparatus 100 may determine whether the feature information on the extracted facial image matches the feature information on the registered facial image and whether the number of expressions such as the number of eye blinks of the extracted facial image and the rotation direction of a head match the registered face movement pattern.

When it is determined at 230 that the extracted facial image and face movement pattern match the registered facial image and face movement pattern, a device is unlocked at 240.

When it is determined at 230 that the extracted facial image and face movement pattern do not match the registered facial image and face movement pattern, the user authentication apparatus 100 may proceed to step 200.

The user authentication method according to an embodiment of the present invention recognizes a face movement pattern as well as a facial image of a user to authenticate a face, and thus it can overcome the vulnerability of security breaches, i.e., a face can be authenticated by using a facial image obtained from a still image such as a photograph.

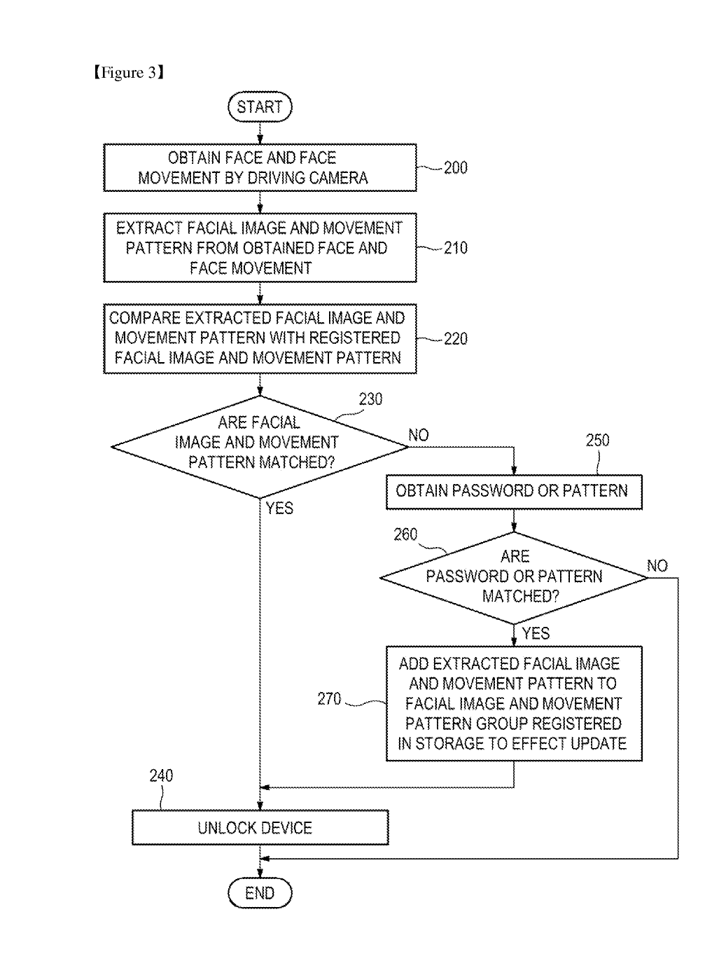

FIG. 3 is a flowchart for describing a user authentication method according to another embodiment of the present disclosure. A password/pattern and/or a facial image and a face movement pattern are pre-registered in the user authentication apparatus 100, and stored in the storage 130. In this case, an operation, in which a user authentication window including a password/pattern authentication window and/or a face authentication window is displayed, is described with respect to FIG. 3.

Steps 200 to 240 of the user authentication method of FIG. 3 are the same as steps 200 to 240 of FIG. 2, and thus their description is not provided, and only steps 250 to 270 will be described in detail.

When it is determined at 230 that the extracted facial image and face movement pattern do not match the registered facial image and face movement pattern, a password/pattern authentication window is displayed, and when a password/pattern is inputted, the password/pattern is obtained at 250.

At 260, it is determined whether the obtained password/pattern matches a password/pattern registered in the storage 130.

When it is determined at 260 that the obtained password/pattern matches the password/pattern registered in the storage 130, the user authentication apparatus 100 adds the extracted facial image and face movement pattern to a facial image and face movement pattern group, which were pre-registered in the storage 130, to effect an update at 270, and proceeds to step 240. In this case, the user authentication apparatus 100 may add a newly scanned facial image and face movement pattern to the pre-registered facial image and face movement pattern group while maintaining the existing registered facial image and face movement pattern, or may replace the existing registered facial image and face movement pattern with the newly scanned facial image and face movement pattern.

When it is determined at 260 that the obtained password/pattern matches the password/pattern registered in the storage 130, the user authentication apparatus 100 may immediately perform step 270. However, depending on the case, the display unit 110 may display a message to request a user's approval as to whether to perform an update through addition. In this case, the user authentication apparatus 100 may perform step 270 when the user approves the update.

If it is determined at 260 that the obtained password/pattern does not match the password/pattern registered in the storage 130, the operation ends.

If the extracted facial image and face movement pattern do not match the registered facial image and face movement pattern, the user authentication method according to another embodiment of the present disclosure compares the obtained password/pattern with the registered password/pattern, and if the obtained password/pattern matches the registered password/pattern, the user authentication method adds the extracted facial image and face movement pattern to the registered facial image and face movement pattern group to effect an update, and unlocks a device. Accordingly, in authenticating a user at a later time, a face is authenticated by performing a face recognition operation using both a recent face of the user and a modified face movement of the user, thus the authenticating success rate can be enhanced.

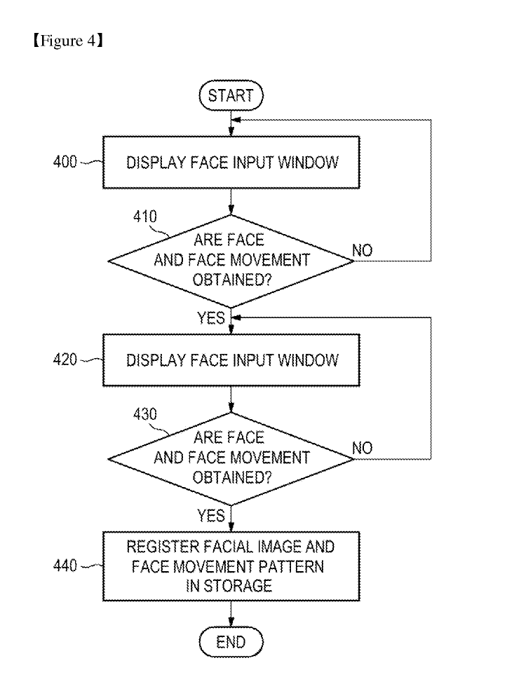

FIG. 4 is a flowchart for describing a face registration operation according to an embodiment of the present disclosure. When a face registration function of the user authentication setting window displayed on the display unit 110 is selected by a user, the face registration operation may be performed.

At 400, a face input window is displayed.

At 410, it is determined whether a face and a face movement are obtained. Here, it may be determined whether the face and the face movement are obtained during a certain time section.

If the face and the face movement are obtained, the face input window is displayed again at 420.

At 430, it is determined whether the face and the face movement are obtained.

If the face and the face movement are obtained, a facial image and a face movement pattern are registered in the storage 130 at 440.

If it is determined at 410 that the face and the face movement are not obtained, the user authentication apparatus 100 proceeds to step 400. If it is determined at 430 that the face and the face movement are not obtained, the user authentication apparatus 100 proceeds to step 420.

In the face registration method according to an embodiment of the present disclosure, a face and a face movement may be registered in the storage 130 by being inputted, for example, two times. However, as described above, the number of times may vary less or greatly.

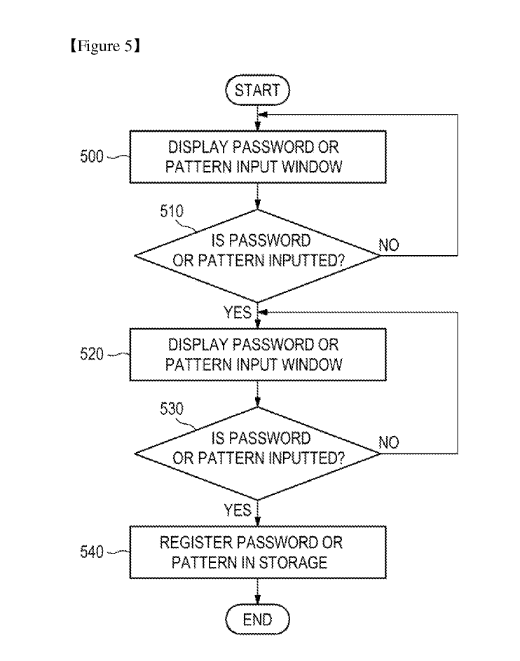

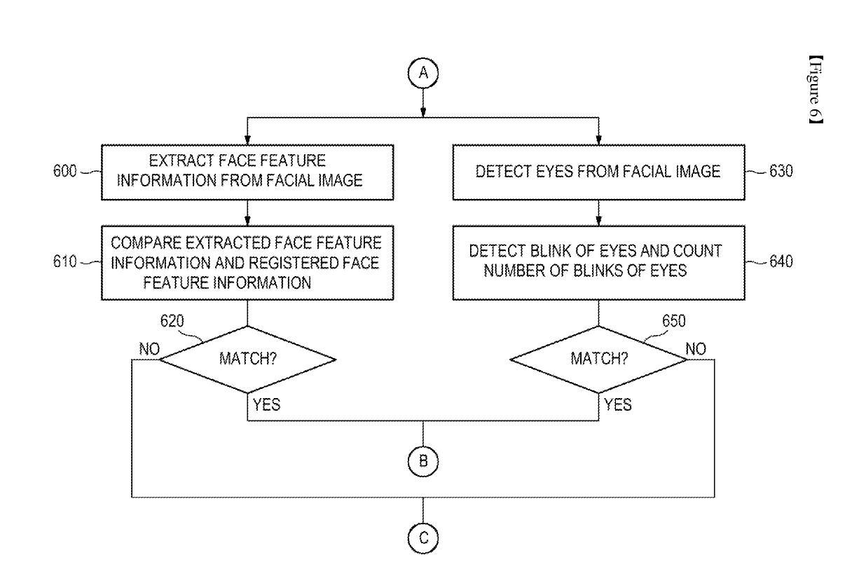

FIG. 5 is a flowchart for describing an operation of registering a password/pattern according to an embodiment of the present disclosure. When a password/pattern registration function of the user authentication setting window displayed on the display unit 110 is selected, the password/pattern registration operation may be performed.

At 500, a password/pattern input window is displayed.

At 510, it is determined whether a password/pattern is inputted.

If the password/pattern is inputted, the password/pattern input window is displayed again at 520.

At 530, it is determined whether the password/pattern is inputted.

If the password/pattern is inputted, the password/pattern is stored in the storage 130 at 540.

If it is determined at 510 that the password/pattern is not inputted, the user authentication apparatus 100 proceeds to step 500. If it is determined at 530 that the password/pattern is not inputted, the user authentication apparatus 100 proceeds to step 520.

In the password/pattern registration method according to an embodiment of the present disclosure, a password/pattern may be registered in the storage 130 by being inputted, for example, two times. However, as described above, the number of times may vary less or greatly.

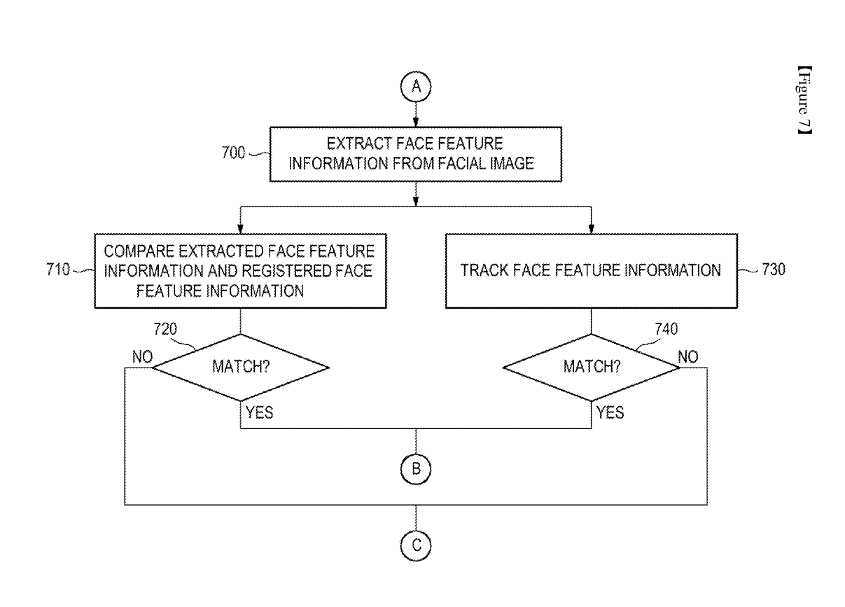

FIG. 6 is a flowchart illustrating an operation that extracts a facial image and a movement pattern from an obtained face and face movement and compares the extracted facial image and movement pattern with a registered facial image and movement pattern, according to an embodiment of the present disclosure. The above extraction operation and the comparison operation correspond to steps 210 and 220 of FIGS. 2 and 3, respectively.

At 600, face feature information is extracted from a facial image.

At 610, the extracted feature information on the facial image is compared with the feature information on a registered facial image.

At 600 and 610, the feature information may include a plurality of feature points or a plurality of feature point descriptors. The feature points may include a face, eyes, eyebrows, a nose, and a mouse, and the feature point descriptors may include descriptors of extracted feature points. Each of the descriptors may be a vector value.

At 620, it is determined whether the extracted feature information on the facial image matches the feature information on the registered facial image.

At 630, eyes are detected from the facial image. If the eyes and feature information on the eyes are detected at 600 and 610, step 630 may be omitted.

At 640, the blink of eyes is detected, and the number of blinks of eyes is counted. By using the blink of eyes, feature information on eyes may be detected from a certain number of facial images (frames) inputted per second, and, by tracking the detected feature information on eyes, the opening and closing of the eyes may be sensed to detect the number of blinks of eyes. Additionally, the blink of eyes may be the blink of both eyes, the blink of a left eye, or the blink of a right eye, and the number of blinks of eyes may be the number of blinks of both eyes, the number of blinks of the left eye, or the number of blinks of the right eye.

Various known technologies may be used in detecting the blink of eyes. As an example, the technology was disclosed in the paper entitled “Communication via Eye Blinks—Detection and Duration Analysis in Real Time” presented by Kristen Grauman et al. at IEEE Society on Computer Vision and Pattern Recognition in December, 2001. The technology may continuously track eyes in frame images, which are continuously inputted, and determine whether eyes are opened or closed in each of the frame images, thereby detecting the blink of eyes.

At 650, it is determined whether the number of blinks of eyes matches the number of blinks of eyes registered in the storage 130.

If it is determined at 650 that the number of blinks of eyes matches the number of blinks of eyes registered in the storage 130, the user authentication apparatus 100 proceeds to step 230 of FIGS. 2 and 3. And, if the feature information on the extracted facial image and the number of blinks of eyes match the feature information on the facial image and the number of blinks of eyes registered in the storage 130, the user authentication apparatus 100 may proceed to step 240 and unlock a device.

When it is determined at 650 that there is a mismatch, the user authentication apparatus 100 may proceed to step 200 of FIGS. 2 and 3.

FIG. 7 is a flowchart illustrating an operation that extracts a facial image and a movement pattern from a captured face and face movement and compares the extracted facial image and movement pattern with a registered facial image and movement pattern, according to another embodiment of the present disclosure. The above extraction operation and the comparison operation correspond to steps 210 and 220 of FIGS. 2 and 3, respectively.

Since steps 700 to 720 of FIG. 7 are the same as steps 600 to 620 of FIG. 6, the description of steps 600 to 620 of FIG. 6 can be applied to steps 700 to 720 of FIG. 7.

After performing step 700, the face feature information is tracked to check a rotation direction of a head at 730. Here, the rotation direction of the head may be checked by tracking the face feature information detected from a certain number of facial images (frames) inputted per second.

Various technologies may be used in tracking a rotation direction of a head. As an example, the technology was disclosed in detail in the paper entitled “Robust head tracking using 3D ellipsoidal head model in particle filter” presented by Choi Seok-won and Kim Dae-jin at the journal of the pattern recognition society in 2008.

At 740, it is determined whether the checked rotation direction of the head matches a rotation direction of a head registered in the storage 130.

If it is determined at 740 that the checked rotation direction of the head matches the rotation direction of the head registered in the storage 130, the user authentication apparatus 100 proceeds to step 230 of FIGS. 2 and 3. And, if the feature information on the extracted facial image and the rotation direction of the head match the feature information on the facial image and the rotation direction of the head registered in the storage 130, the user authentication apparatus 100 may proceed to step 240 and unlock a device.

If it is determined at 740 that there is a mismatch, the user authentication apparatus 100 may proceed to step 200 of FIGS. 2 and 3.

Additionally, by combining the method using movements of eyes in FIG. 6 and the method using a movement of a head in FIG. 7, the user authentication apparatus 100 may register two-time blink of eyes and one-time right rotation of a head as a movement pattern, and then authenticate the movement pattern. In addition, by combining various expressions, user authentication may be performed.

The user authentication apparatus according to an embodiment of the present disclosure may be applied to a door lock device for authenticating a plurality of users as well as smart phones or tablet PCs for authenticating a user.

The above-described embodiments of the present disclosure can be implemented as computer readable codes in a computer readable medium. The computer readable recording medium may include a program instruction, a local data file, a local data structure, or a combination thereof. The computer readable recording medium may be specific to exemplary embodiments of the present disclosure or commonly known to those of ordinary skill in computer software. The computer readable recording medium includes all types of recordable media in which computer readable data are stored. Examples of such computer readable recording medium may include a magnetic medium, such as a hard disk, a floppy disk and a magnetic tape, an optical medium, such as a CD-ROM and a DVD, a magneto-optical medium, such as a floptical disk, and a hardware memory, such as a ROM, a RAM and a flash memory, specifically configured to store and execute program instructions. Examples of the program instruction may include machine code, which is generated by a compiler, and a high level language, which is executed by a computer using an interpreter and so on. The above-described hardware apparatus may be configured to operate as one or more software modules for performing the operation of the present disclosure, and the reverse case is similar.

While certain embodiments have been described, these embodiments have been presented by way of example only, and are not intended to limit the scope of the disclosures. Indeed, the novel methods and apparatuses described herein may be embodied in a variety of other forms; furthermore, various changes, modifications, corrections, and substitutions with regard to the embodiments described herein may be made without departing from the spirit of the disclosures.

Therefore, the accompanying claims and their equivalents including the foregoing modifications are intended to cover the scope and spirit of the disclosures, and are not limited by the present disclosures.

1. A method of authenticating a user, comprising:
(a) obtaining an image comprising a face and a face movement by driving a camera to extract feature information on a facial image and a movement pattern from the obtained image; and
(b) comparing the extracted feature information on the facial image with feature information on a facial image registered in a storage and, when the extracted feature information matches the registered feature information, comparing the extracted movement pattern with a movement pattern registered in the storage and, when the extracted movement pattern matches the registered movement pattern, unlocking a device,
wherein,
the movement pattern is at least one of the number of blinks of eyes and a rotation direction of a head, and
the feature information comprises descriptors of feature points.

2. The method according to claim 1, wherein,
the step (a) comprises obtaining a certain number of facial images inputted for a predetermined time, extracting feature information on eyes from a certain number of the facial images, and detecting the number of blinks of eyes by tracking the feature information on the eyes, and
the step (b) comprises unlocking the device when the extracted feature information on the facial image matches the feature information on the registered facial image and the number of detected blinks of eyes matches the registered number of blinks of eyes.

3. The method according to claim 1, wherein,
the step (a) comprises obtaining a certain number of facial images inputted for a predetermined time, and detecting a rotation direction of the head by tracking feature information on a certain number of the facial images, and
the step (b) comprises unlocking the device when the extracted feature information on the facial image matches the feature information on the registered facial image and the detected rotation direction of the head matches the registered rotation direction of the head.

4. The method according to claim 1, wherein,
the step (a) comprises obtaining a certain number of facial images inputted for a predetermined time, extracting feature information on eyes from a certain number of the facial images, detecting the number of blinks of eyes by tracking the feature information on the eyes, and detecting a rotation direction of the head by tracking feature information on a certain number of the facial images, and
the step (b) comprises unlocking the device when the extracted feature information on the facial image matches the feature information on the registered facial image, the number of detected blinks of eyes matches the registered number of blinks of eyes, and the detected rotation direction of the head matches the registered rotation direction of the head.

5. The method according to claim 1, further comprising:
(c) comparing the extracted feature information on the facial image with the feature information on the facial image registered in the storage and the extracted movement pattern with the movement pattern registered in the storage and, when there is a mismatch therebetween, requesting a password or a pattern; and
(d) comparing the password or pattern with a password or pattern registered in the storage and, when the password or pattern matches the registered password or pattern, unlocking the device, and adding the extracted feature information on the facial image and the extracted movement pattern to the storage to effect an update,
wherein the step (d) comprises comparing the password or pattern with the password or pattern registered in the storage and, when the password or pattern matches the registered password or pattern, unlocking the device, and replacing the feature information on the facial image and the movement pattern, registered in the storage, with the extracted feature information on the facial image and the extracted movement pattern to effect an update.

6. The method according to claim 1, further comprising:
(c) comparing the extracted feature information on the facial image with the feature information on the facial image registered in the storage, and the extracted movement pattern with the movement pattern registered in the storage and, when there is a mismatch therebetween, requesting a password or a pattern; and
(d) comparing the password or pattern with a password or pattern registered in the storage and, when the password or pattern matches the registered password or pattern, unlocking the device, and adding the extracted feature information on the facial image and the extracted movement pattern to the storage to effect an update,
wherein the step (d) comprises comparing the password or pattern with the password or pattern registered in the storage and, when the password or pattern matches the registered password or pattern, unlocking the device, and adding the extracted feature information on the facial image and the extracted movement pattern to a group of facial images registered in the storage to effect an update.

7. The method according to claim 1, further comprising:
(c) comparing the extracted feature information on the facial image with the feature information on the facial image registered in the storage, and the extracted movement pattern with the movement pattern registered in the storage and, when there is a mismatch therebetween, requesting a password or a pattern; and
(d) comparing the password or pattern with a password or pattern registered in the storage and, when the password or pattern matches the registered password or pattern, unlocking the device, and adding the extracted feature information on the facial image and the extracted movement pattern to the storage to effect an update,
wherein the step (d) comprises:
(d1) comparing the password or pattern with the password or pattern registered in the storage and, when the password or pattern matches the registered password or pattern, unlocking the device;
(d2) requesting approval from the user as to whether to add the extracted feature information on the facial image to effect an update; and
(d3) adding, when the user approves the update, the extracted feature information on the facial image to the storage to effect an update.

8. The method according to claim 1, further comprising:
(c) comparing the extracted feature information on the facial image with the feature information on the facial image registered in the storage and the extracted movement pattern with the movement pattern registered in the storage and, when there is a mismatch therebetween, requesting a password or a pattern; and
(d) comparing the password or pattern with a password or pattern registered in the storage and, when the password or pattern matches the registered password or pattern, unlocking the device, and adding the extracted feature information on the facial image and the extracted movement pattern to the storage to effect an update, and
further comprising, before the step (a), registering the password or pattern and the face and face movement in the storage,
wherein registering the password or pattern and the face and face movement in the storage comprises inputting the password or pattern n times and inputting the face and face movement m times to register the password or pattern and the feature information on the facial image and the movement pattern.

9. The method according to claim 8, wherein registering the password or pattern and the face and face movement in the storage comprises extracting the feature information on the registered facial image, extracting feature information on eyes from the registered facial image, detecting the number of blinks of eyes by tracking the feature information on the eyes, and storing the feature information on the facial image and the number of blinks of eyes.

10. The method according to claim 8, wherein registering the password or pattern and the face and face movement in the storage comprises extracting the feature information on the registered facial image, obtaining a rotation direction of the head by tracking the feature information on the registered facial image, and storing the feature information on the facial image and the rotation direction of the head.

11. The method according to claim 8, wherein registering the password or pattern and the face and face movement in the storage comprises extracting the feature information on the registered facial image, extracting feature information on eyes from the registered facial image, detecting the number of blinks of eyes by tracking the feature information on the eyes, obtaining a rotation direction of the head by tracking the feature information on the registered facial image, and storing the feature information on the facial image, the number of blinks of eyes, and the rotation direction of the head.

12. An apparatus for authenticating a user, comprising:
a storage for storing a registered facial image and a registered movement pattern;
a camera for scanning a face;
a display unit for displaying a face authentication window; and
a control unit for providing the face authentication window to the display unit, obtaining an image comprising a face and a face movement by driving a camera for authenticating the face to extract feature information on a facial image and a movement pattern from the obtained image, comparing the extracted feature information on the facial image with feature information on the facial image registered in the storage and, when the extracted feature information matches the registered feature information, comparing the extracted movement pattern with the movement pattern registered in the storage and, when the extracted movement pattern matches the registered movement pattern, unlocking a device,
wherein,
the movement pattern is at least one of the number of blinks of eyes and a rotation direction of a head, and
the feature information comprises descriptors of feature points.

13. The apparatus according to claim 12, wherein the control unit obtains a certain number of facial images inputted for a predetermined time, extracts feature information on eyes from a certain number of the facial images, detects the number of blinks of eyes by tracking the feature information on the eyes, and unlocks the device when the extracted feature information on the facial image matches the feature information on the registered facial image and the number of detected blinks of eyes matches the registered number of blinks of eyes.

14. The apparatus according to claim 12, wherein the control unit obtains a certain number of facial images inputted for a predetermined time, detects a rotation direction of the head by tracking feature information on a certain number of the facial images, and unlocks the device when the extracted feature information on the facial image matches the feature information on the registered facial image and the detected rotation direction of the head matches the registered rotation direction of the head.

15. The apparatus according to claim 12, wherein the control unit obtains a certain number of facial images inputted for a predetermined time, extracts feature information on eyes from a certain number of the facial images, detects the number of blinks of eyes by tracking the feature information on the eyes, and detects a rotation direction of the head by tracking feature information on a certain number of the facial images, and unlocks the device when the extracted feature information on the facial image matches the feature information on the registered facial image, the number of detected blinks of eyes matches the registered number of blinks of eyes, and the detected rotation direction of the head matches the registered rotation direction of the head.

16. The apparatus according to claim 12, wherein,
the storage additionally stores a registered password or a registered pattern,
the display unit additionally displays a password or pattern authentication window, and a password or a pattern is additionally inputted through the password or pattern authentication window,
the control unit compares the inputted password or pattern with the registered password or pattern, and, when the inputted password or pattern matches the registered password or pattern, the control unit unlocks the device and adds the extracted feature information on the facial image and the extracted movement pattern to the storage to effect an update, and
the control unit compares the inputted password or pattern with the password or pattern registered in the storage and, when the inputted password or pattern matches the registered password or pattern, the control unit unlocks the device and replaces the feature information on the facial image and the movement pattern, registered in the storage, with the extracted feature information on the facial image and the extracted movement pattern to effect an update.

17. The apparatus according to claim 12, wherein,
the storage additionally stores a registered password or a registered pattern,
the display unit additionally displays a password or pattern authentication window, and a password or a pattern is additionally inputted through the password or pattern authentication window,
the control unit compares the inputted password or pattern with the registered password or pattern, and, when the inputted password or pattern matches the registered password or pattern, the control unit unlocks the device and adds the extracted feature information on the facial image and the extracted movement pattern to the storage to effect an update, and
the control unit compares the inputted password or pattern with the password or pattern registered in the storage and, when the inputted password or pattern matches the registered password or pattern, the control unit unlocks the device and adds the extracted feature information on the facial image and the extracted movement pattern to a group of facial images registered in the storage to effect an update.

18. The apparatus according to claim 12, wherein,
the storage additionally stores a registered password or a registered pattern,
the display unit additionally displays a password or pattern authentication window, and a password or a pattern is additionally inputted through the password or pattern authentication window,
the control unit compares the inputted password or pattern with the registered password or pattern, and, when the inputted password or pattern matches the registered password or pattern, the control unit unlocks the device and adds the extracted feature information on the facial image and the extracted movement pattern to the storage to effect an update, and
before adding feature information on the scanned facial image to the storage to effect an update, the control unit displays a message to request approval from the user as to whether to add the feature information on the scanned facial image to effect an update, and, when the user approves the update, the control unit adds the feature information on the scanned facial image to the storage to effect an update.

19. The apparatus according to claim 12, wherein,
the storage additionally stores a registered password or a registered pattern,
the display unit additionally displays a password or pattern authentication window, and a password or a pattern is additionally inputted through the password or pattern authentication window,
the control unit compares the inputted password or pattern with the registered password or pattern, and, when the inputted password or pattern matches the registered password or pattern, the control unit unlocks the device and adds the extracted feature information on the facial image and the extracted movement pattern to the storage to effect an update, and
the storage stores a user authentication application, and, when the user requests an approach to the user authentication apparatus, the control unit executes the user authentication application.

20. The apparatus according to claim 19, wherein,
the control unit executes the user authentication application to provide a user authentication setting window, and provides a function of registering the password or pattern and a function of registering the face through the user authentication setting window, and
the display unit displays the user authentication setting window, and displays the function of registering the password or pattern and the function of registering the face.

21. The apparatus according to claim 20, wherein,
when the function of registering the password or pattern is selected, the control unit successively provides a password or pattern input window to the display unit n times, and, when the same password or pattern is successively inputted through the password or pattern input window n times, the control unit stores the password or pattern as the registered password or pattern in the storage, and
when the function of registering the face is selected, the control unit drives the camera and successively provides a face input window to the display unit m times, and, when the same face and face movement are successively inputted through the face input window m times, the control unit extracts feature information on the face and a movement pattern of the face and stores the extracted feature information on the face and the extracted movement pattern of the face as the feature information on the registered facial image and the registered movement pattern in the storage.

22. The apparatus according to claim 12, further comprising a transceiver for accessing a user authentication application providing server for downloading the user authentication application from the user authentication application providing server.

23. The apparatus according to claim 12, wherein the control unit stores the feature information on the registered facial image and the registered movement pattern in the storage, extracts the feature information and the movement pattern from the obtained facial image, and compares the extracted feature information on the facial image and the extracted movement pattern with the feature information on the facial image and the movement pattern which are registered in the storage.

24. A computer readable recording medium having instructions thereon which, when executed by a processor, performs operations comprising:
(a) obtaining an image comprising a face and a face movement by driving a camera to extract feature information on a facial image and a movement pattern from the obtained image; and
(b) comparing the extracted feature information on the facial image with feature information on a facial image registered in a storage and, when the extracted feature information matches the registered feature information, comparing the extracted movement pattern with a movement pattern registered in the storage and, when the extracted movement pattern matches the registered movement pattern, unlocking a device,
wherein,
the movement pattern is at least one of the number of blinks of eyes and a rotation direction of a head, and
the feature information comprises descriptors of feature points.

25. The computer readable medium according to claim 24, wherein,
the step (a) comprises obtaining a certain number of facial images inputted for a predetermined time, extracting feature information on eyes from a certain number of the facial images, and detecting the number of blinks of eyes by tracking the feature information on the eyes, and
the step (b) comprises unlocking the device when the extracted feature information on the facial image matches the feature information on the registered facial image and the number of detected blinks of eyes matches the registered number of blinks of eyes.
